(19) United States
(12) Patent Application Publication
(10) Pub. No.: US 2005/0155241 A1
(43) Pub. Date: Jul. 21, 2005

(54) Bubble element for a spirit level

(76) Inventor: Wolfgang Scheyer, Gotzis (AT)

Correspondence Address: Friedrich Kueffner, Suite 910, 317 Madison Avenue, New York, NY, 10017, US

(21) Appl. No.: 11/038,745

(22) Filed: Jan. 18, 2005

(30) Foreign Application Priority Data
Jan. 19, 2004 (DE) 20 2004 000 780.0

(51) Int. Cl. G01C 9/24

(52) U.S. Cl. 33/379

(57) ABSTRACT

A bubble element for a spirit or water level includes a bubble element body composed of a transparent material and having a hollow interior containing a bubble element fluid and marking rings for indicating a center position of a bubble enclosed in the bubble element fluid. At least over a middle portion of the bubble element body in the longitudinal direction which contains the marking rings, an upper side of the bubble element body has a surface which curves around the longitudinal axis of the bubble element body, wherein the curved surface is connected with a continuous curvature and without edges to side surfaces of the bubble element body. At least over the middle portion of the bubble element body, the surface forming the upper side of the bubble element body extends additionally convexly curved in the longitudinal direction of the bubble element body and, seen in the longitudinal center section of the bubble element body, the wall thickness of the bubble element body increases in the middle portion toward the middle of the longitudinal extension of the bubble element body.

### BACKGROUND OF THE INVENTION

1. Field of the Invention

The present invention relates to a bubble element for a spirit or water level. The bubble element includes a bubble element body composed of a transparent material. The bubble element body has a hollow interior containing a bubble element fluid and is provided with marking rings for indicating a center position of a bubble which is enclosed in the bubble element fluid. At least in a portion of the bubble element body which is in the middle in relation to the longitudinal extension of the bubble element body and which contains the marking rings for indicating the center position of the bubble, the upper side of the bubble element body is constructed as a surface which curves around the longitudinal axis of the bubble element body, wherein the curved surface is connected with a continuous curvature and without edges to the side surfaces of the bubble element body.

2. Description of the Related Art

Bubble elements for spirit or water levels are known in the art in the form of so-called tubular bubble elements. These elements are constructed as tubes having relatively thin walls and a drum-shaped hollow interior into which the bubble element fluid is filled. The drum-shaped hollow interior is formed by injection molding the tube of plastic material, wherein a forced demolding of the tube takes place which for this purpose is constructed with thin walls.

Also known in the art are so-called block bubble elements. In this case, the bubble element body is injection molded initially with a cylindrical, slightly conical hollow interior which is subsequently hollowed out by turning to form the cylindrical or drum shape of the interior. Such a block bubble element, which may have a relatively great wall thickness, is described, for example, in EP 0 987 520 B1.

In addition to block bubble elements having a cylindrical outer contour of the bubble element body, also known in the art are bubble elements having a parallelepiped outer contour which facilitates fastening of the bubble element in the holder for mounting the bubble element. In this connection, a bubble element is known in the art in which an enlarging lens is formed in the upper side of the bubble element body, so that a convexly arched surface of the bubble element body in the longitudinal direction of the bubble element body is obtained in the area of the enlarging lens. The enlarging lens has the purpose of optically enlarging the bubble in the bubble element fluid.

Block bubble elements having a parallelepiped outer contour have the disadvantage that, when the bubble element is looked at from a direction which is rotated relative to the viewing direction perpendicularly on the bubble element about the longitudinal axis of the bubble element, the bubble must be viewed through the corner between the upper side and the side surface. As a result, the bubble appears double, so that reading the bubble element is made difficult.

Also known in the art are block-type bubble elements which are constructed with a corner in the bottom area, i.e., between the bottom side and the side surfaces, and which are rounded at the upper side, wherein the surface forming the upper side of the bubble element body is curved about the longitudinal axis of the bubble element body and is connected to the side surfaces of the bubble element body without edges along a continuous curvature. The curved surface extending between the side surfaces across the upper side is constructed semi-cylindrical. This has the disadvantage that, when the bubble element is viewed from a position which is located centrally above the middle portion of the bubble element as seen in the longitudinal direction, the portions of the marking rings extending on the side of the hollow interior facing away from the observer appear optically to be further inwardly than the portions of the marking rings which are located on the side of the hollow interior facing the observer, so that the exact reading of the position of the bubble element relative to the marking rings is made more difficult.

### SUMMARY OF THE INVENTION

It is the primary object of the present invention to provide a bubble element for a spirit or water level which can be read more easily.

In accordance with the present invention, this object is met by a bubble element for a water or spirit level in which, at least over the middle portion of the bubble element body in which the marking rings for indicating the center position of the bubble are located, the surface forming the upper side of the bubble element body extends additionally convexly curved in the longitudinal direction of the bubble element body and, seen in the longitudinal center section of the bubble element body, the wall thickness of the bubble element body increases in the area of the upper side of this middle portion of the bubble element body toward the middle of the longitudinal extension of the bubble element body.

Accordingly, the bubble element according to the present invention is provided with a double curvature on its upper side at least in a middle portion of the bubble element body in which the marking rings for indicating the center position of the bubble are located, i.e., the upper side is curved about the longitudinal axis of the bubble element body as well as in the direction of the longitudinal axis of the bubble element body.

The bubble element according to the present invention makes it possible to achieve such an optical configuration of the marking rings that, when viewing the bubble element form an area perpendicularly above the longitudinal middle of the bubble element, at least with a viewing distance of between 15 cm and 40 cm, the portion of the marking rings (which extends over the bottom side of the hollow interior) appears to be further outwardly than the portion of the marking rings located on the side of the observer (which extends over the upper side of the hollow interior), or is at least covered by the area of the marking rings located on the side of the observer. Viewing the position of the bubble is simplified as a result. In addition, due to the configuration of the bubble element body with a double curvature, reading of the bubble element is possible even from a position which is rotated about the longitudinal axis of the bubble element in relation to the position located perpendicularly above the bubble element, without having to view the bubble through a corner. Therefore, the bubble element according to the present invention facilitates a simple and precise reading. In addition, a certain optical enlargement is achieved.

The various features of novelty, which characterize the invention, are pointed out with particularity in the claims annexed to and forming part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of an embodiment of the bubble element according to the present invention;

FIG. 2 is a side view of the bubble element shown in FIG. 1;

FIG. 3 is a front view of the bubble element shown in FIG. 1;

FIG. 4 is a sectional view taken along sectional line A-A of FIG. 3;

FIGS. 5 and 6 are sectional views taken along sectional lines B-B and C-C, respectively, of FIG. 2;

FIG. 7 shows an embodiment of a spirit level with a bubble element mounted therein;

FIG. 8 is a perspective view of an end cap of the spirit level of FIG. 7;

FIGS. 9 and 10 are a side view and a front view, respectively, of the end cap of FIG. 8;

FIG. 11 is a sectional view taken along sectional line D-D of FIG. 10; and

FIG. 12 is a sectional view taken along sectional line E-E of FIG. 10.

### DETAILED DESCRIPTION OF THE INVENTION

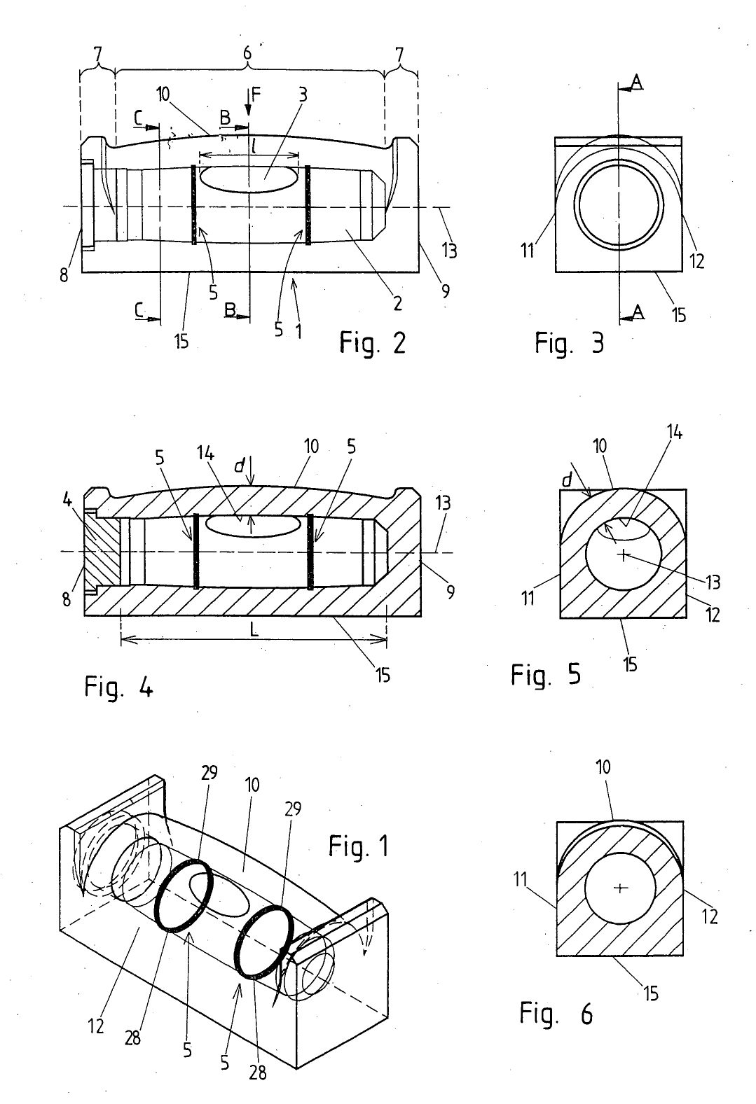

FIGS. 1 to 6 of the drawing show an embodiment of the bubble element according to the present invention. The bubble element includes a bubble element body 1 composed of a transparent material. The bubble element body 1 has a conventional drum-shaped or cylindrically shaped hollow interior 2. The hollow interior 2 contains a bubble element fluid with a bubble 3 enclosed in the fluid. The bubble 3 can be formed especially by a gaseous medium, such as air. The hollow interior 2 is closed off by a closing cover 4. Also, the bubble element body 1 is provided with two marking rings 5 for indicating the center position of the bubble 3.

Adjacent to a middle portion 6 of the bubble element body 1 as seen in the longitudinal direction of the bubble element, in which the marking rings 5 for indicating the center position of the bubble 3 are located, the bubble element body 1 has assembly sections 7 which form the two end faces 8, 9 of the bubble element body 1. These two end faces 8, 9 of the bubble element body 1 are of the assembly sections 7 and are preferably rectangular. This facilitates the mounting of the bubble element body 1 in a holder.

Along the extension of the middle portion 6 of the bubble element body 1, the upper side 10 of the bubble element body 1 is formed by a surface which is curved about the longitudinal axis 13 of the bubble element body 1, wherein the curved surface is connected to the side surfaces 11, 12 of the bubble element body 1 through a continuous curvature without the formation of a corner or edge.

Along this middle portion 6, in which the two marking rings 5 are located, the surface forming the upper side 10 of the bubble element body 1 extends in the longitudinal direction of the bubble element body 1 so as to be outwardly arched or convexly curved. As seen in the longitudinal middle portion of the bubble element body 1 shown in FIG. 4, the wall thickness d of the bubble element body 1 increases in the area of its upper side 10 (i.e. the thickness of the wall portion between the upper side 10 and the hollow interior 2 of the bubble element body 1) toward the middle in longitudinal direction (which coincides with the sectional line B-B in FIG. 2). Accordingly, the upper side 10 has a smaller radius of curvature than the upper limitation 14 of the hollow interior 2. Advantageously, as seen in the longitudinal center section of the bubble element body 1 (FIG. 4), the radius of curvature of the upper side 10 is between 70 and 100 mm, preferably between 80 and 90 mm, and the radius of curvature of the upper limitation 14 of the hollow interior 2 is between 150 and 1200 mm.

The wall thickness d of the bubble element body preferably increases at least in the area of the longitudinal middle from the side surfaces 11, 12 toward the upper side 10, as seen in FIG. 5. For example, the radius of curvature of the surface which connects the upper side 10 with the side surfaces 11, 12 may be between 6.5 and 9 mm as seen in the cross-sectional view through the longitudinal middle along sectional line B-B, and the corresponding radius of curvature of the limitation of the hollow interior 2 is between 4 and 5.5 mm.

The side surfaces 11, 12 are connected to the bottom side 15 of the bubble element body 1 through right angles.

The bubble element is constructed as a block-type bubble element, i.e., the bubble element body 1 is formed by an injection molded part which is initially provided with a hollow interior which is cylindrical or increases conically toward its opening for facilitating demolding, wherein the interior is then further hollowed out by turning to provide the cylindrical cone shape of the hollow interior.

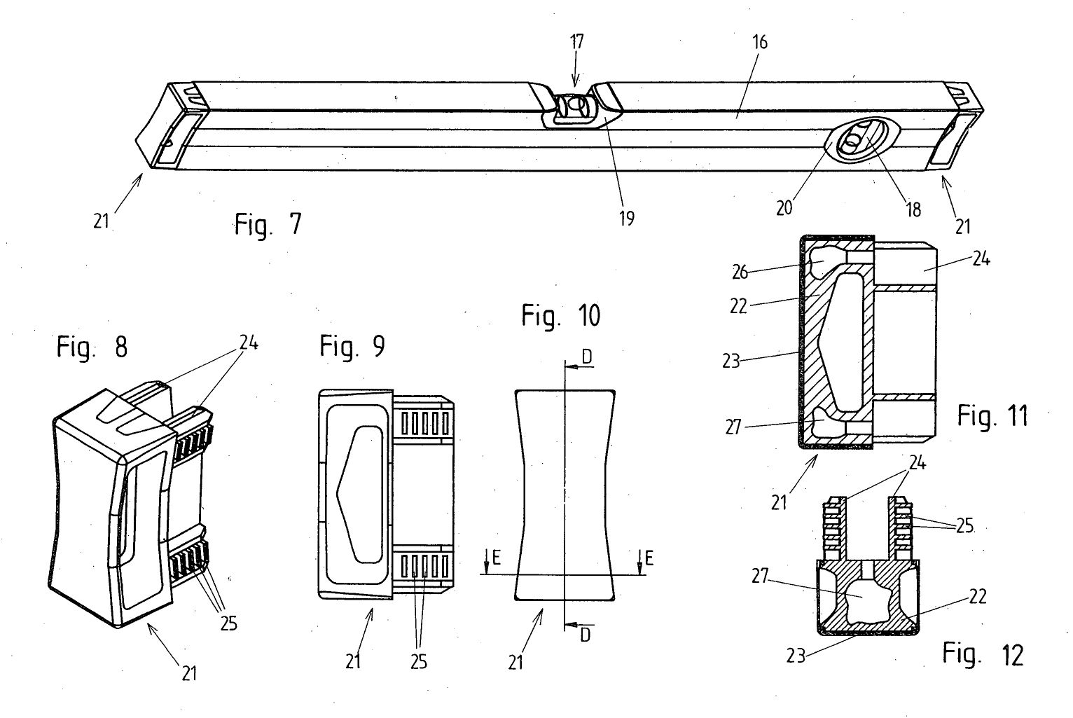

FIG. 7 is a perspective view of a spirit level in which the bubble element 17 illustrated in FIGS. 1 to 6 is mounted for horizontal measurements. The spirit level has a spirit level body 16 in the form of a hollow aluminum section which is provided with recesses for inserting the bubble element 17, 18 for horizontal and vertical measurements. The measuring surface of the spirit levels is located on the side which is not visible in FIG. 7. The upper side of the bubble element 17 for horizontal measurements is facing away from the measuring surface.

The bubble elements 17, 18 are mounted by means of holders which may be of conventional construction. The holders are covered by covers 19, 20.

The bubble element body 16 is provided with end caps 21 at its end faces. The end caps are formed of plastic material, wherein preferably a harder plastic material 22 is used with a coating of a softer plastic material 23. The projection 24 formed by the harder plastic material 22 for insertion in the bubble element body 16 has lamellae 25 which interact with the inner wall of the bubble element body and act against pulling of the inserted end cap 21 out of the spirit level body.

The end caps 21 are manufactured by injection molding, wherein preferably a gas injection molding process with pressurized internal gas is used. This makes it possible to form hollow interiors 26, 27; this reduces the amount of material used and improves damping of the end cap.

In a bubble element according to the present invention, it is possible to achieve such an optical image that, when viewing perpendicularly onto the bubble element and from an area above the longitudinal middle in viewing direction F as shown in FIGS. 2 and 5, at least for a viewing distance between 15 and 40 cm, the lower portions 28 of the marking rings 5 are each covered by the upper portion 29 or are even visible outside the area between the upper portion 29 and the two marking rings 5.

Preferably, the middle portion 6 along which the bubble element body 1 is double arched, extends at least over half of the longitudinal extension 1 of the bubble 3 on both sides of the area between the two marking rings 5. It is particularly preferred if this double curved middle portion extends at least over the length 1 of the longitudinal extension of the hollow interior 2.

Different modifications of the illustrated embodiment of the invention are conceivable and possible without departing from the invention. For example, in addition to the two marking rings 5 which indicate the center position of the bubble 3, further marking rings may be provided which indicate a certain inclined position of the bubble level.

The invention is not limited by the embodiments described above which are presented as examples only but can be modified in various ways within the scope of the protection defined by the appended patent claims.

1. A bubble element for a spirit or water level, the bubble element comprising a bubble element body composed of a transparent material and having a longitudinal axis, the bubble element body comprising a hollow interior containing a bubble element fluid and provided with marking rings for indicating a center position of a bubble enclosed in the bubble element fluid, wherein, at least in a middle portion of the bubble element body which is in a middle position in relation to the longitudinal extension of the bubble element body and which contains the marking rings for indicating the center position of the bubble, an upper side of the bubble element body has a surface which curves around the longitudinal axis, wherein the curved surface is connected with a continuous curvature and without edges to side surfaces of the bubble element body, and wherein, at least over the middle portion of the bubble element body which contains the marking rings for indicating the center position of the bubble, the surface forming the upper side of the bubble element body extends additionally convexly curved in the longitudinal direction of the bubble element body and, seen in the longitudinal center section of the bubble element body, a wall thickness of the bubble element body increases in the area of the upper side of the middle portion toward the middle of the longitudinal extension of the bubble element body.

2. The bubble element according to claim 1, wherein the increase of the wall thickness of the bubble element body in the area of the upper side of the bubble element body toward the middle of the longitudinal extension of the bubble element body is continuous.

3. The bubble element according to claim 1, wherein the wall thickness of the bubble element body increases continuously at least in an area of the middle of the longitudinal extension from the side surfaces toward the upper side of the bubble element body.

4. The bubble element according to claim 1, wherein the bubble element body has adjacent to the middle portion thereof assembly sections which form rectangular end faces of the bubble element body.

5. The bubble element according to claim 5, wherein the hollow interior of the bubble element body is drum-shaped.

6. The bubble element according to claim 1, wherein the middle portion of the bubble element body over which the bubble element body is curved about the longitudinal axis as well as in the longitudinal direction, extends at least by half the length of the bubble in both directions beyond the area defined by the two marking rings for indicating the center position of the bubble.

7. The bubble element according to claim 6, wherein the middle portion extends at least over a length of the hollow interior containing the bubble element fluid.

8. The bubble element according to claim 1, wherein, seen in the longitudinal center section of the bubble element body, the radius of the upper side of the bubble element body is at least in the middle portion of the bubble element body between 70 and 100 mm.

9. The bubble element according to claim 8, wherein the radius is between 80 and 90 mm.

10. The bubble element according to claim 1, wherein, seen in the longitudinal center section of the bubble element body, a radius of an upper limitation of the hollow interior of the bubble element body is at least in the middle portion of the bubble element body between 150 and 1200 mm.

11. The bubble element according to claim 10, wherein, seen in the longitudinal center section of the bubble element body, a radius of a lower limitation of the hollow interior of the bubble element body is at least in the middle portion of the bubble element body between 150 and 1200 mm.

12. The bubble element according to claim 1, wherein, seen in a cross-section of the middle of the longitudinal extension of the bubble element body, a radius of a surface connecting the upper side to the side surfaces of the bubble element body is between 6.5 and 9 mm.

13. A spirit or water level comprising a bubble element for horizontal measurements, the bubble element comprising a bubble element body composed of a transparent material and having a longitudinal axis, the bubble element body comprising a hollow interior containing a bubble element fluid and provided with marking rings for indicating a center position of a bubble enclosed in the bubble element fluid, wherein, at least in a middle portion of the bubble element body which is in a middle position in relation to the longitudinal extension of the bubble element body and which contains the marking rings for indicating the center position of the bubble, an upper side of the bubble element body has a surface which curves around the longitudinal axis, wherein the curved surface is connected with a continuous curvature and without edges to side surfaces of the bubble element body, and wherein, at least over the middle portion of the bubble element body which contains the marking rings for indicating the center position of the bubble, the surface forming the upper side of the bubble element body extends additionally convexly curved in the longitudinal direction of the bubble element body and, seen in the longitudinal center section of the bubble element body, a wall thickness of the bubble element body increases in the area of the upper side of the middle portion toward the middle of the longitudinal extension of the bubble element body.

14. The spirit or water level according to claim 13, comprising end caps composed of a harder plastics material and a layer of a softer plastics material extending over at least over a portion of the surface of the harder plastics material.

15. The spirit or water level according to claim 14, wherein the end caps contain hollow interiors which are closed toward an outer side of the level.
